(19) United States
(12) Patent Application Publication
(10) Pub. No.: US 2007/0172219 A1
(43) Pub. Date: Jul. 26, 2007

(54) PHOTOGRAPHIC DEVICE WITH ANTI-SHAKE FUNCTION

(75) Inventors: Kosei KOSAKO, Tokyo (JP); Hirokazu MAEDA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/625,891

(22) Filed: Jan. 23, 2007

(30) Foreign Application Priority Data
Jan. 24, 2006 (JP) 2006-015274

(51) Int. Cl. G03B 17/00

(52) U.S. Cl. 396/55

(57) ABSTRACT

A photographic device includes a shake detector, a shake mitigator, a shake controller, and a shutter speed setter. The shake detector detects a shake of the photographic device. The shake mitigator mitigates the shake to reduce the effect of the shake on a photographed subject image. The shake controller controls the shake mitigator. The shutter speed setter sets a shutter speed of the photographic device for photographing the subject image. The shake controller controls the shake mitigator so that the shake mitigator mitigates the shake only when a shutter speed that is lower than the maximum shutter speed is set.

### BACKGROUND OF THE INVENTION

1. Field of the Invention

The present invention relates to a photographic device that has an anti-shake function, especially to a photographic device where the anti-shake function is controllable.

2. Description of the Related Art

Photographic devices, such as cameras, which have an anti-shake function to prevent a shake in a generated subject image have become widespread. In digital cameras, for example, anti-shake function is achieved by moving an imaging device or a photographing lens, or by other methods.

The effects on a subject image caused by a shake of a camera may be different, even if the same amount of shaking occurs. Therefore, when almost no adverse effect is caused by a shake of a camera, anti-shake operation may be carried out unnecessarily. In such a case, large amounts of electronic power are consumed ineffectively, the effect of which may cause the life of the battery to be shortened.

### SUMMARY OF THE INVENTION

Therefore, the objective of the present invention is to provide a photographic device with an anti-shake function that can be controlled to function only when it is effective.

A photographic device, according to the present invention, includes a shake detector, a shake mitigator, a shake controller, and a shutter speed setter. The shake detector detects a shake of the photographic device. The shake mitigator mitigates the shake to reduce the effect of the shake on a photographed subject image. The shake controller controls the shake mitigator. The shutter speed setter sets the shutter speed of the photographic device for photographing the subject image. The shake controller controls the shake mitigator so that the shake mitigator mitigates the shake only for a shutter speed set lower than the maximum shutter speed.

### BRIEF DESCRIPTION OF THE DRAWINGS

The present invention will be better understood from the description of the preferred embodiment of the invention set forth below, together with the accompanying drawings in which:

FIG. 1 is a block diagram of a digital camera of an embodiment of the present invention;

FIG. 2 is a graph representing a first example of maximum shutter speed values that are set in accordance with a photographing lens;

FIG. 3 is a graph representing a second example of maximum shutter speed values that are set in accordance with a photographing lens; and

FIG. 4 is a flowchart of a shake mitigation control routine.

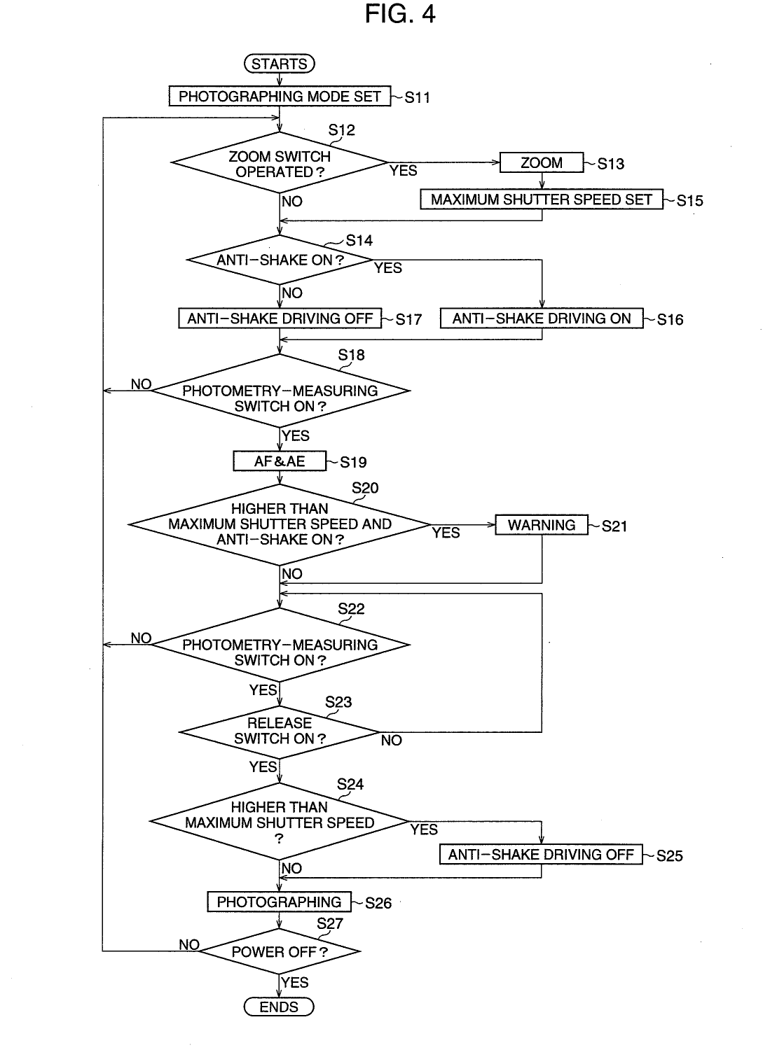

### DESCRIPTION OF THE PREFERRED EMBODIMENT

Hereinafter, the first embodiment of the present invention is described with reference to the attached drawings.

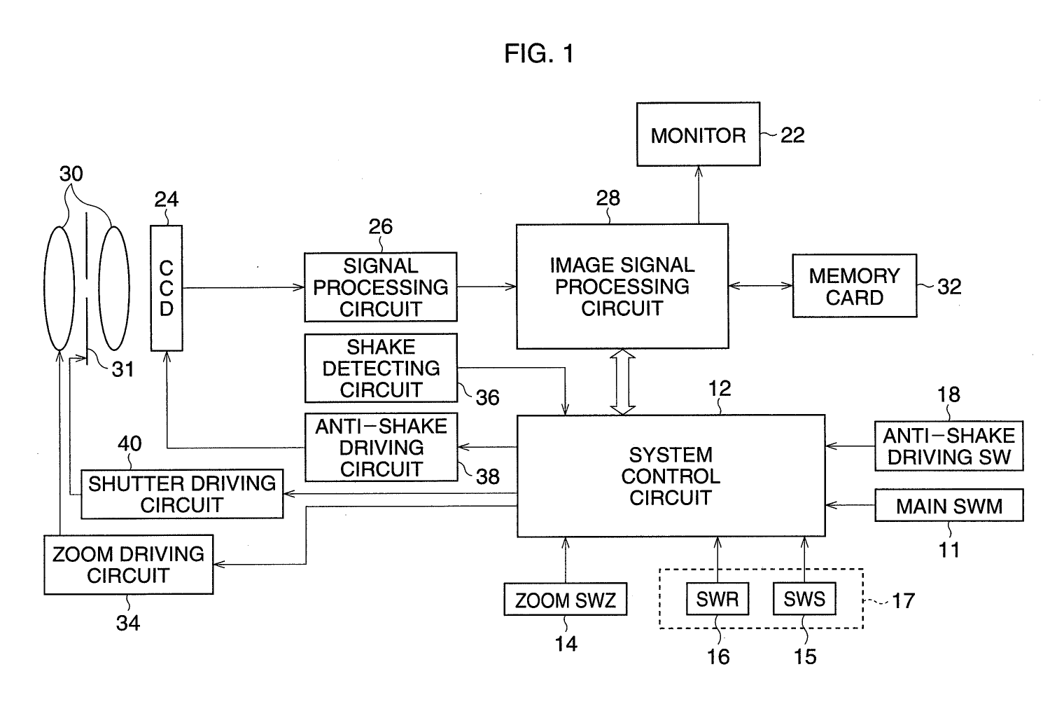

As shown in FIG. 1, in a digital camera of this embodiment, a system control circuit 12 that controls the entire the digital camera is provided. The digital camera has a main switch SWM 11. When the main switch SWM 11 is turned on by an operation of a user, the system control circuit 12 starts. To the system control circuit 12, a zoom switch (SWZ) 14, a photometry-measuring switch (SWS) 15, a release switch (SWR) 16, and an anti-shake driving switch (SW) 18, and so on, are connected. Signals corresponding to operations of these switches are transmitted to the system control circuit 12. On a surface of the digital camera, a release button 17 (an indication commander), to turn on and off the photometry-measuring switch 15 and release switch 16, is provided.

In the digital camera, a capture mode in which a subject is photographed and a still image of a subject is generated, a replay mode in which a photographed subject image is replayed, and other modes can be set by an operation of a mode dial (not shown). Further, in the digital camera, a monitor 22 to display a subject image is provided. When the capture mode is set, a subject image is displayed on the monitor 22 as a through image, before a still image is generated, as explained below.

First, a CCD 24 (an imaging device) receives reflected light from a subject through a photographing lens 30 that is a zoom lens. As a result, electric charges corresponding to a subject are generated in the CCD 24. The electric charges read from the CCD 24, that is, the image signals, are transmitted to a signal processing circuit 26. At the signal processing circuit 26, image signals are processed to reduce noise, and are converted from analog signals to digital signals. The processed image signals are transmitted to an image signal processing circuit 28.

In the image signal processing circuit 28, various processes are carried out on the digital image signals, such as white balance adjustment, gamma correction, and so on, and then luminance signals and color-difference signals are generated. The generated luminance signals and color-difference signals, that is, the image data, are transmitted to the monitor 22. As a result, a subject image is displayed on the monitor 22 as a through image.

When the release button 17 is half-depressed, the photometry-measuring switch 15 that is connected to the system control circuit 12 is turned on. When the photometry-measuring switch 15 is on state, distance-measuring operations by a distance measurement element and photometric operations by a photometry measurement element (both not shown) are carried out. Obtained distance data and photometry data are transmitted to the system control circuit 12. The system control circuit 12 controls a focusing operation based on the distance data, and calculates an exposure value based on the photometry data.

When the release button 17 is fully depressed, the release switch 16 is turned on, and then, the shutter speed and an aperture value for a shutter 31 are set by the system control circuit 12. As a result, an aperture (not shown) is opened by a predetermined amount, a shutter 31 is opened to a predetermined position for a predetermined time by a shutter driving circuit 40, and then the CCD 24 is exposed. In the CCD 24, image signals are generated and read from the CCD 24. A still image is generated, based on the read image signals, and displayed on the monitor 22. The image data of a still image are stored in a memory card 32.

When the zoom switch 14 is operated, signals for telephotographing or wide angle photographing are transmitted to the system control circuit 12. The system control circuit 12 transmits order signals, which orders focal distance adjustments of the photographing lens 30, to a zoom driving circuit 34, in accordance with the received signals. As a result, the photographing lens 30 is moved to a zoom position where the focal distance is a predetermined value corresponding to the operation of the zoom switch 14.

In the digital camera, a shake detecting circuit 36 (a shake detector) that detects a shake of the digital camera is provided. In the shake detecting circuit 36, a gyro sensor, a high-pass filter, and other elements (none of which are shown) are provided. The shake detecting circuit 36 detects a shake by a known method. From the shake detecting circuit 36, signals representing the amount of the detected shake are transmitted to the system control circuit 12.

Based on the signals output from the shake detecting circuit 36, the system control circuit 12 transmits order signals to an anti-shake driving circuit 38 (a shake mitigator) to control the CCD 24 for shake reduction. The CCD 24 is slightly driven, that is, the CCD 24 is slightly moved in a direction perpendicular to the optical axis of the photographing lens 30 by a predetermined amount by the anti-shake driving circuit 38 to mitigate a shake of the digital camera and to reduce the effect of a shake on a photographed subject image. As a result, a shake of the digital camera is mitigated or canceled out by the movement of the CCD 24, and an image with a subject that has not been shaken, can be generated.

Note that shake mitigation by the shake detecting circuit 36 and the anti-shake driving circuit 38 is carried out while the capture mode is set, in principle. However, when the capture mode is set, shake mitigation may not be carried out as explained below.

When the anti-shake driving switch 18 is turned on while the capture mode is set, the system control circuit 12 (a maximum shutter speed setter) calculates and sets a maximum shutter speed of the shutter 31. And then, whether or not an actual shutter speed is lower than the maximum shutter speed is determined by the system control circuit 12. As a result, shake mitigation is carried out only when it is determined that the actual shutter speed is lower than the maximum shutter speed. The reason for this is because at high enough shutter speeds almost no shake of a generated subject image will result from a shake of the digital camera, thus the shake mitigation is not required.

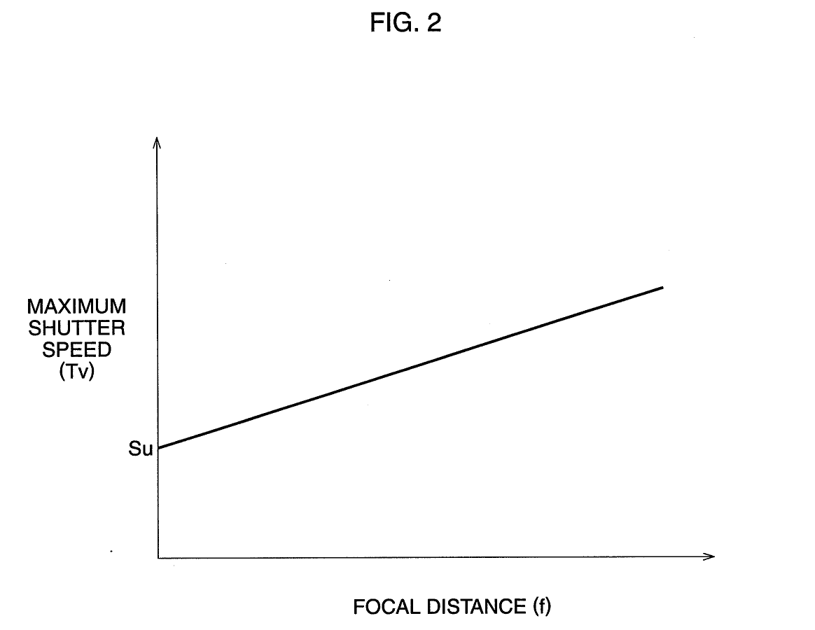

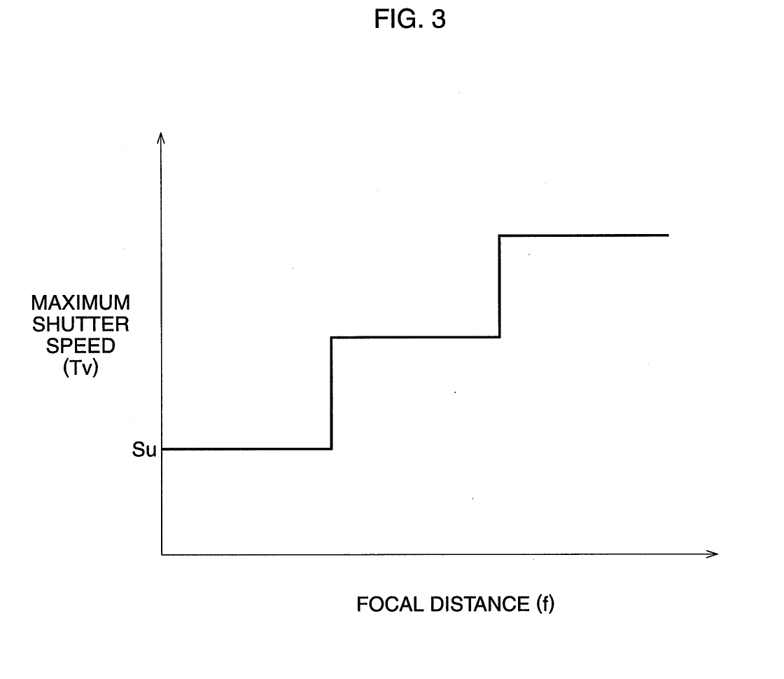

The maximum shutter speed Su (see FIGS. 2 and 3) is set in accordance with the focal distance “f” of the photographing lens 30 by the system control circuit 12. That is, the larger the focal distance “f” of the photographing lens 30, the higher the maximum shutter speed set by the system control circuit 12 (the value of the maximum shutter speed Su (Tv) is large), and the smaller the focal distance “f”, the lower the maximum shutter speed set (the value of the maximum shutter speed Su (Tv) is small).

This is because when the focal distance “f” is large and a subject is telephotographed, a small shake of the digital camera tends to amplify a shake of a generated still subject image, requiring a high maximum shutter speed Su and calling for shake mitigation over a wide range of shutter speeds. On the other hand, when the focal distance “f” is small and a subject is photographed in wide angle, a shake of the digital camera tends to effect hardly any shake of a generated still subject image, in which case the maximum shutter speed Su is lowered and an unnecessary shake mitigation is not carried out.

For example, in FIGS. 2 and 3, when a shutter speed Sa that is actually set higher than the maximum shutter speed Su and the value of the shutter speed Sa (Tv) is larger than that of the maximum shutter speed Su (Tv), that is, the value of the actual shutter speed Sa (Tv) is in an area above each of the straight lines representing the maximum shutter speed Su (Tv) in FIGS. 2 and 3, and is larger than the that of the maximum shutter speed Su (Tv) at the corresponding focal distance “f”, the shake detecting circuit 36 and the anti-shake driving circuit 38 do not function and a shake mitigation is not carried out.

Note that the maximum shutter speed Su (Tv) may be a linear function with the focal distance “f” (see FIG. 2), or it may be a step function with a constant value in a predetermined range of the focal distance “f” (see FIG. 3). In the former case, a shake mitigation can be finely controlled but the calculating process can be complex, and in the latter case, a shake mitigation can be less finely controlled but the calculating process can be simple.

The shake mitigation control routine starts when the main switch 11 of the digital camera is turned on. At step S11, the capture mode is set, and the process proceeds to step S12. At step S12, it is determined whether or not the zoom switch 14 is operated; when it is determined that the zoom switch 14 is operated, the process proceeds to step S13, but when it is determined that the zoom switch 14 is not operated, the process proceeds to step S14.

At step S13, the photographing lens 30 is driven in accordance with the operation of the photographing lens 30, and the zoom position thereof is adjusted. At the following step S15, a new maximum shutter speed Su (Tv) corresponding to the changed zoom position of the photographing lens 30 is calculated and set by the system control circuit 12, then the process proceeds to step S14.

At step S14, it is determined whether or not the anti-shake driving switch 18 is turned on, that is, whether or not anti-shake operation is commanded. As a result, when it is determined that the anti-shake operation is commanded, the process proceeds to step S16, but when it is determined that the anti-shake operation is not commanded, the process proceeds to step S17. At step S16 the anti-shake operation is carried out, but at step S17, it is not carried out. After step S16 or S17, the process proceeds to step S18.

At step S18, it is determined whether or not the photometry-measuring switch 15 is on state. When it is determined that the photometry-measuring switch 15 is on state, the process proceeds to step S19, and when it is determined that the photometry-measuring switch 15 is off state, the process returns to step S12. At step S19, focusing control and exposure control are carried out, and the process then proceeds to step S20.

At step S20, it is determined whether or not the actual shutter speed Sa, calculated in exposure control at step S19, is higher than the maximum shutter speed Su, and whether or not the anti-shake driving switch 18 was turned on at step S14. When the actual shutter speed Sa is determined to be higher than the maximum shutter speed Su, and the anti-shake driving switch 18 was turned on (S16), the process proceeds to step S21. On the other hand, when it is determined that the actual shutter speed Sa is lower than or equal to the maximum shutter speed Su, or that the anti-shake driving switch 18 was turned off (S17), the process proceeds to step S22.

At step S21, an icon for warning that the anti-shake operation is not being carried out at the exposure time (the photographing time) regardless of the command, is superimposed on a through image on the monitor 22 (an indicator). Further, at that same time, the actual shutter speed Sa (Tv) that has been set is also displayed on the through image beside the icon. Therefore, a user can easily judge whether the anti-shake operation is carried out or not at the exposure time. Note that in a case where the anti-shake operation is carried out as commanded, another icon is displayed on the monitor 22 to represent this fact. As explained above, when the photometry-measuring switch 15 is turned on by the half-depression of the release button 17 at step S18, the monitor 22 indicates whether or not the anti-shake operation is carried out.

When the anti-shake operation is carried out, a user can see a subject image as a through image to which the anti-shake operation is carried out. Note that an indication of whether or not the anti-shake operation has been applied to the image is not limited to the use of icons, but may also be indicated by, for example, a message on the monitor 22. Further, the maximum shutter speed Su (Tv) may also be indicated with icons on the monitor 22.

At step S22, it is determined whether or not the photometry-measuring switch 15 is on state. When it is determined that the photometry-measuring switch 15 is on state, the process proceeds to step S23. On the other hand, when it is determined that the photometry-measuring switch 15 is off state at step S22, the process returns to step S22.

At step S24, whether or not the actual shutter speed Sa is higher than the maximum shutter speed Su, that is, whether or not the anti-shake operation is carried out, is determined. When it is determined that the actual shutter speed Sa is higher than the maximum shutter speed Su, and that the anti-shake operation is not carried out, the process then proceeds to step S25. On the other hand, when it is determined that the actual shutter speed Sa is lower than or equal to the maximum shutter speed Su, and that the anti-shake operation is carried out, the process then proceeds to step S26. At step S25, the shake detecting circuit 36 and the anti-shake driving circuit 38 are turned off, then the process proceeds to step S26.

At step S26, a subject is photographed and a generated still subject image is stored in a storage medium such as the memory card 32. The process then proceeds to step S27, where it is determined if the main switch 11 and power source for the digital camera are turned off or not. When it is determined that the power source for the digital camera is turned off, the shake mitigation control routine ends. On the other hand, when it is determined that the power source for the digital camera stays on state, the process returns to step S12.

As explained above, in this embodiment, the anti-shake operation can be carried out only when it is effective, so that unnecessary anti-shake operation and the corresponding reduction of battery life can be prevented in the digital camera.

Although it is affixed to a digital camera in this embodiment, this device is not limited to use with a digital camera, that is, the anti-shake mechanism including the shake detecting circuit 36 and the anti-shake driving circuit 38 can be applied to other photographic devices that can generate a still image. For example, the anti-shake mechanism may be adapted to a camera with a single focal lens, a single-lens reflex camera, a silver-halide film camera, or other photographic device.

The value of the actual shutter speed Sa may not be automatically calculated and set by the system control circuit 12, but a user can set the value of the actual shutter speed Sa. Further, the maximum shutter speed Su can be similar to the actual shutter speed Sa.

The system control circuit 12 may control the shutter speed of the electronic shutter of the CCD 24, instead of the shutter 31. In this case, when a through image is displayed on the monitor 22, a determination whether or not to carry out the anti-shake operation is made by the system control circuit 12, based on the focal distance “f” of the photographing lens 30 and the electronic shutter speed of the CCD 24, so that the shake detecting circuit 36 and the anti-shake driving circuit 38 are controlled in a manner similar to this embodiment.

The shake mitigation function may be carried out under various situations, although it is carried out only when the capture mode is set in this embodiment. For example, shake mitigation may or may not be carried out, as desired, in a camera where a plurality of modes can be set, such as a mode where shake mitigation is always active, a mode where shake mitigation is active only when a predetermined button has been operated, and a mode where the shake mitigation function has been deactivated.

The method of shake mitigation is not limited to the driving of the CCD 24 by the anti-shake driving circuit 38 and other elements that are adopted in this embodiment. For example, driving the photographing lens 30 or processing the image signals generated in the CCD 24 may also be used to reduce the effect of a shake on a subject image.

This invention is not limited to that described in the preferred embodiment, namely, various improvements and changes may be made to the present invention without departing from the spirit and scope thereof.

The present disclosure relates to subject matter contained in Japanese Patent Application No. 2006-015274 (filed on Jan. 24, 2006), which is expressly incorporated herein, by reference, in its entirety.

1. A photographic device comprising:
a shake detector that detects a shake of said photographic device;
a shake mitigator that mitigates said shake to reduce the effect of said shake on a photographed subject image;
a shake controller that controls said shake mitigator; and
a shutter speed setter that sets a shutter speed of said photographic device for photographing said subject image;
said shake controller controlling said shake mitigator so that said shake mitigator mitigates said shake only when a shutter speed that is lower than a maximum shutter speed is set.

2. The photographic device according to claim 1, further comprising a zoom lens and a maximum shutter speed setter that sets said maximum shutter speed in accordance with a focal distance of said zoom lens.

3. The photographic device according to claim 2, wherein the larger the said focal distance of said zoom lens, the higher the said maximum shutter speed set by said maximum shutter speed setter.

4. The photographic device according to claim 1, further comprising an indicator that indicates whether said shake mitigator mitigates said shake or not.

5. The photographic device according to claim 4, wherein said indicator further indicates said shutter speed that is set by said shutter speed setter, and whether said shake mitigator mitigates said shake or not, at the same time.

6. The photographic device according to claim 4, wherein said indicator further indicates said subject image, and whether or not said shake mitigator mitigates said shake, at the same time.

7. The photographic device according to claim 4, further comprising an indication commander that commands said indicator to indicate whether said shake mitigator mitigates said shake or not, said indicator indicating whether said shake mitigator mitigates said shake or not based on the first operation of said indication commander, said subject image being photographed based on the second operation of said indication commander.

8. The photographic device according to claim 4, further comprising a shake mitigation commander that commands said shake mitigator to mitigate said shake, said indicator indicating a warning message when said shake mitigator is not mitigating said shake, regardless of the command by said shake mitigation commander.

9. The photographic device according to claim 1, further comprising an imaging device that receives light from a subject, wherein said shake mitigator moves said imaging device so that the effect of said shake on a photographed subject image is reduced.
